(19) United States
(12) Patent Application Publication
(10) Pub. No.: US 2010/0254239 A1
(43) Pub. Date: Oct. 7, 2010

(54) METHOD FOR ADJUSTING TILT OF OPTICAL PICK-UP HEAD

(76) Inventors: Yao Wen LIU, Hsinchu (TW); Tsai Cheng-Hsiu, Taipei (TW)

Correspondence Address: Muncy, Geissler, Olds & Lowe, PLLC, 4000 Legato Road, Suite 310, FAIRFAX, VA, 22033, US

(21) Appl. No.: 12/690,526

(22) Filed: Jan. 20, 2010

(30) Foreign Application Priority Data
Apr. 7, 2009 (TW) 098111562

(51) Int. Cl. G11B 7/00

(52) U.S. Cl. 369/53.28; G9B/7

(57) ABSTRACT

The present invention relates to a method for calibrating a focus position of an optical pick-up. The optical pick-up is located on a focus position at a preset distance from a recordable optical medium to emit a recording beam of a preset power to the recordable optical medium so that corresponding optical data are recorded in the recordable optical medium. The method includes: altering a focus position of the optical pick-up during a recording process to generate a corresponding write radio frequency (RF) signal; detecting a minimum value of the write RF signal and a corresponding object focus position; and moving the optical pick-up to the object focus position so that the optical pick-up performs recording at the object focus position in the recordable optical medium.

This application claims priority of No. 098111562 filed in Taiwan R.O.C. on Apr. 7, 2009 under 35 USC 119, the entire content of which is hereby incorporated by reference.

### BACKGROUND OF THE INVENTION

1. Field of the Invention

The present invention relates in general to a method and a system for calibrating a focus position of an optical pick-up, and more particularly to a method and a system for calibrating a focus position of an optical pick-up used in a recordable/read-write optical device.

2. Related Art

Conventionally, when writing data in a recordable optical medium, the pick-up uses the focus error zero crossing point as the focus position to perform writing. However, discs tend to have a slanting or uneven surface because of the unstable manufacturing process. Hence, this preset focus position is not necessarily the optimal focus position; the optimal focus position actually changes throughout the process of recording. Indeed, the quality of recordable optical media recorded by a recordable/read-write optical device may fluctuate since the optical pick-up is either too close to or too far away from the recordable optical media such that the quality of reading from the recordable optical media is also affected.

FIG. 1 is a schematic diagram showing the variation of a write radio frequency (RF) signal throughout the process of writing data at a specific focus position in a recordable optical medium. First, when the optical pick-up starts emitting a beam for writing, a detecting module generates a corresponding write RF signal, i.e. a level A; then, when the writing beam has been emitted for some time, a detecting module generates a more stable write RF signal, i.e. a level B. Further, when the optical pick-up stops emitting the writing beam and reverts to a read power, the detecting module shifts from a stable and higher write RF signal to a lower level voltage, i.e. a level C. Existing methods for calibrating the pick-up by use a focus position corresponding to the level B as an object focus position. However, in practice, the process of going from the level A to level B contains a relatively unstable stage, and therefore the level B thus achieved tends to be inaccurate.

### SUMMARY OF THE INVENTION

It is therefore an objective of the present invention to provide a method for calibrating a focus position of an optical pick-up so that the focus position of the optical pick-up is adjusted throughout a process of writing to effectively solve the existing problem of unstable recording quality.

The method for calibrating the focus position provided in the present invention uses the shift from the level B voltage to the level C voltage of the write RF signal as a detecting level voltage. When the write RF signal is detected as having transformed from a high level voltage to a low level voltage, a minimum write RF signal value and its corresponding object focus position are obtained. Further, the focus position of the optical pick-up is adjusted to the object focus position so as to effectively solve the problem of unstable recording quality.

Based upon the above formulation, the present invention provides a method for calibrating a focus position of an optical pick-up. The optical pick-up is located at a focus position having a preset distance from a recordable optical medium to emit a writing beam of a preset power to the recordable optical medium and write corresponding optical data in the recordable optical medium. The method for calibrating the focus position includes:

1) performing writing with a focus position in the recordable optical medium to generate a corresponding write RF signal;

2) detecting whether the write RF signal transforms from a high level voltage to a low level voltage; if yes, proceeding to 3);

3) obtaining a minimum write RF signal value and a corresponding object focus position;

4) adjusting the optical pick-up to the object focus position so that the optical pick-up performs subsequent writing at the object focus position in the recordable optical medium.

In order to achieve the above-identified method for calibrating the focus position of the optical pick-up, the present invention further provides a system for calibrating a focus position of an optical pick-up. The system includes:

a detecting module, for detecting a writing beam reflected from the recordable optical medium and generating a corresponding RF signal;

a controlling module, which includes a position-altering unit, for controlling the optical pick-up to alter the focus position with a preset position-altering program during writing in the recordable optical medium; a level-transformation-detecting unit, for outputting a transformation signal when detecting that the RF signal generated by the detecting module transforms from a high level voltage to a low level voltage; and an extreme-value-generating unit, for obtaining a minimum value of the RF signal and a corresponding object focus position according to the transformation signal; and

a driving module, for adjusting the optical pick-up to the object focus position according to the control of the controlling module.

The present invention further provides another method for calibrating a focus position of an optical pick-up. The optical pick-up is located at a focus position having a preset distance from a recordable optical medium to emit a writing beam of a preset power to the recordable optical medium and write corresponding optical data in the recordable optical medium. The method includes:

1) performing writing at a focus position in the recordable optical medium to generate a corresponding RF signal;

2) pausing writing and re-reading the written optical data to generate a corresponding RF signal;

3) obtaining an amplitude absolute value of the RF signal;

4) altering the focus position and repeating 1) to obtain a maximum amplitude absolute value and its corresponding object focus position;

5) adjusting the optical pick-up to the object focus position so that the optical pick-up performs subsequent writing at the object focus position in the recordable optical medium.

In order to achieve the above-identified another method for calibrating the focus position of the optical pick-up, the present invention further provides another system for calibrating a focus position of an optical pick-up. The system includes:

a detecting module, for detecting the beam reflected from the recordable optical medium and generating a corresponding RF signal;

a controlling module, which includes a position-altering unit, for controlling the optical pick-up with a preset position-altering program to alter the focus position during writing in the recordable optical medium; a re-reading and detecting unit, for pausing writing and then re-reading and detecting a corresponding RF signal generated by written data to obtain an amplitude absolute value; an amplitude-calculating unit, for receiving the amplitude absolute value and determining a maximum value of the amplitude absolute value and a corresponding object focus position; and

a driving module, for adjusting the optical pick-up to the object focus position according to the control of the controlling module.

The advantages of the above-identified methods and systems lie in that the focus position is continuously adjusted according to an undershoot voltage value or amplitude absolute value of the write RF signal during the writing process so that the entire disc has a consistent writing quality throughout. Alternatively, the object focus position of any random position is determined by the results of adjusting the focus positions of a plurality of points.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an oscillogram of a write radio frequency (RF) signal according to the first embodiment of the present invention.

FIG. 2A is an oscillogram of a write RF signal according to the first embodiment of the present invention.

FIG. 2B shows a flowchart of a method for calibrating a focus position according to the first embodiment of the present invention.

FIG. 2C shows a system for calibrating a minimum write RF signal value of the focus position of the optical pick-up according to the first embodiment of the present invention.

FIG. 3A is an oscillogram of a write RF signal according to the second embodiment of the present invention.

FIG. 3B shows a flowchart of a method for calibrating a focus position according to the second embodiment of the present invention.

FIG. 3C shows a system for calibrating a maximum undershoot response time of an optical pick-up according to the third embodiment of the present invention.

FIG. 4A is an oscillogram of a RF signal according to the third embodiment of the present invention.

FIG. 4B shows a flowchart of a method for calibrating a focus position according to the third embodiment of the present invention.

FIG. 4C shows a system for calibrating a maximum modulation value of the focus position of the optical pick-up according to the third embodiment of the present invention.

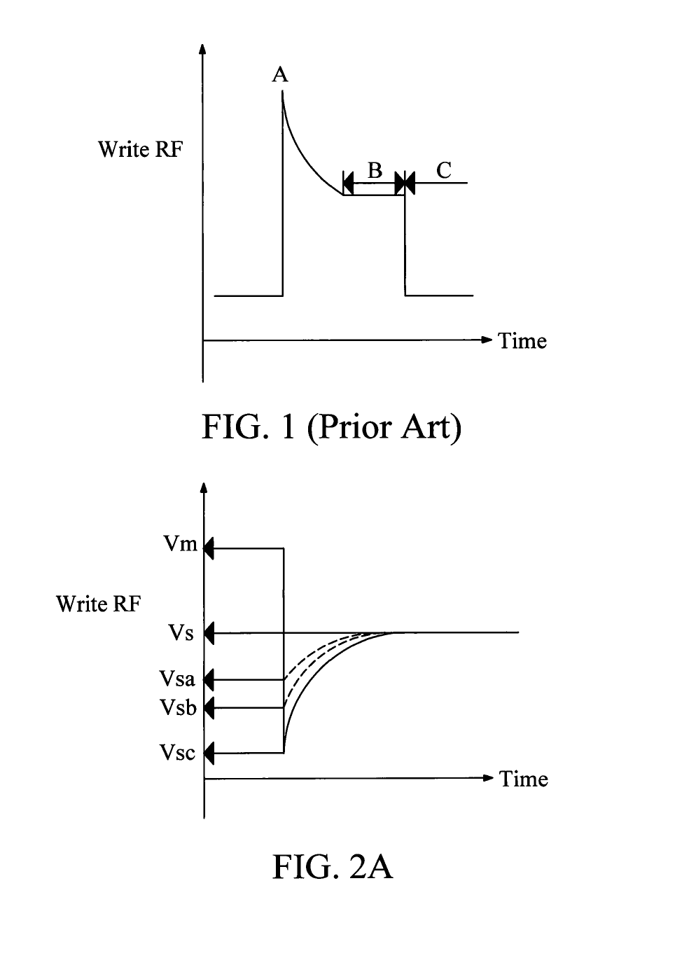

### DETAILED DESCRIPTION OF THE INVENTION

The present invention will be apparent from the following detailed description, which proceeds with reference to the accompanying drawings, wherein the same references relate to the same elements.

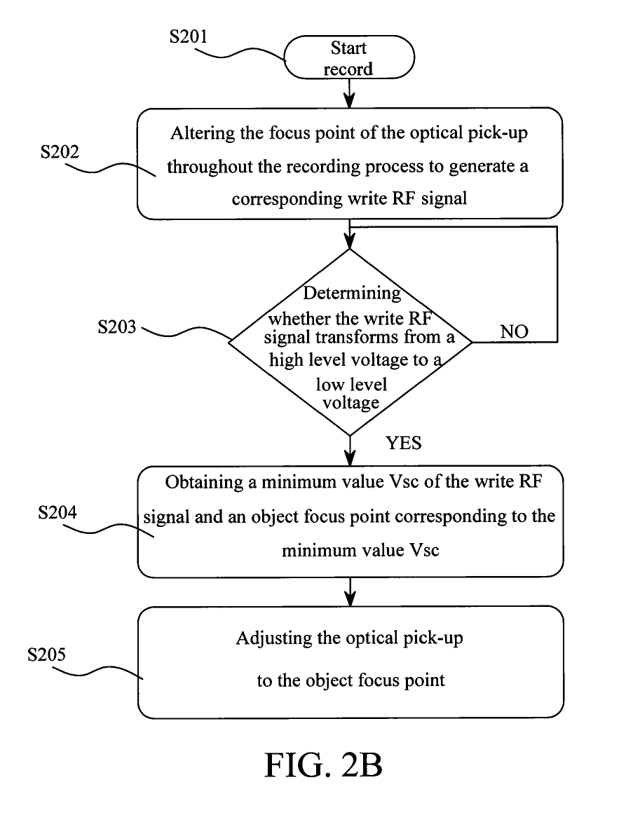

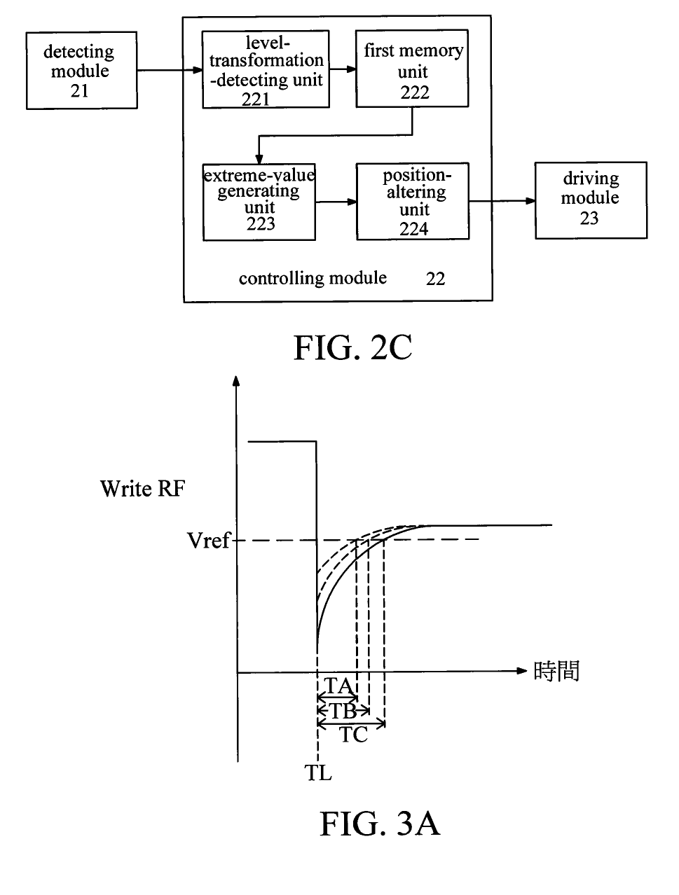

FIG. 2A is an oscillogram of a write radio frequency (RF) signal according to the first embodiment of the present invention. Referring to FIG. 2A, this oscillogram is obtained during writing when a write power of an optical pick-up is set as a read power to create a space section in a disc. In the conventional disc technology, the write RF signal is defined as follows:

Write RF=write power×R,

wherein R is a reflection rate. Since the optical pick-up is using a laser optical head to generate the space section in the disc at the moment, the read power is relatively lower and the power is fixed, the better the focus of the optical pick-up is, the lower an undershoot voltage of the oscillogram is. Further, FIG. 2B shows a flowchart of a method for calibrating a focus position according to the first embodiment of the present invention. Referring to both FIGS. 2A and 2B, in the first embodiment, the method for calibrating the focus position of the optical pick-up includes:

Step S201: Starting writing;

Step S202: Altering the focus position of the optical pick-up during writing process to generate a corresponding write RF signal;

Step S203: Determining whether the write RF signal transforms from a high level voltage to a low level voltage, when determined as yes, proceeding Step S204, when determined as no, continuing to execute Step S203;

Step S204: Obtaining a minimum value Vsc of the write RF signal and an object focus position corresponding to the minimum value Vsc;

Step S205: Adjusting the optical pick-up to the object focus position so that the optical pick-up performs subsequent writing at the object focus position in the recordable optical medium.

The present invention further provides a system for calibrating a minimum write RF signal value of a focus position of an optical pick-up corresponding to the method disclosed in the first embodiment. Referring to FIG. 2C, FIG. 2C illustrates a detecting module 21, a controlling module 22, and a driving module 23:

the detecting module 21, for detecting a writing beam reflected from the recordable optical medium and generating a corresponding RF signal;

the controlling module 22, including a level-transformation-detecting unit 221, a first memory unit 222, an extreme-value-generating unit 223, and a position-altering unit 224, wherein
the level-transformation-detecting unit 221 outputs a transformation signal when detecting that the RF signal generated by the detecting module 21 transforms from a high level voltage to a low level voltage;
the first memory unit 222 records a voltage value of the current write RF signal when receiving the transformation signal outputted by the level-transformation-detecting unit 221;
the extreme-value-generating unit 223 receives the voltage value from the first memory unit 222 and determines a minimum value of the voltage corresponding to the minimum value of the RF signal and a corresponding object focus position; and
the position-altering unit 224 controls the optical pick-up with a preset position-altering program to alter the focus position during writing in the recordable optical medium; and

the driving module 23, for adjusting the optical pick-up to the object focus position corresponding to the minimum voltage value according to the control of the controlling module 22. Herein, the RF signal refers to the write RF signal generated during writing process.

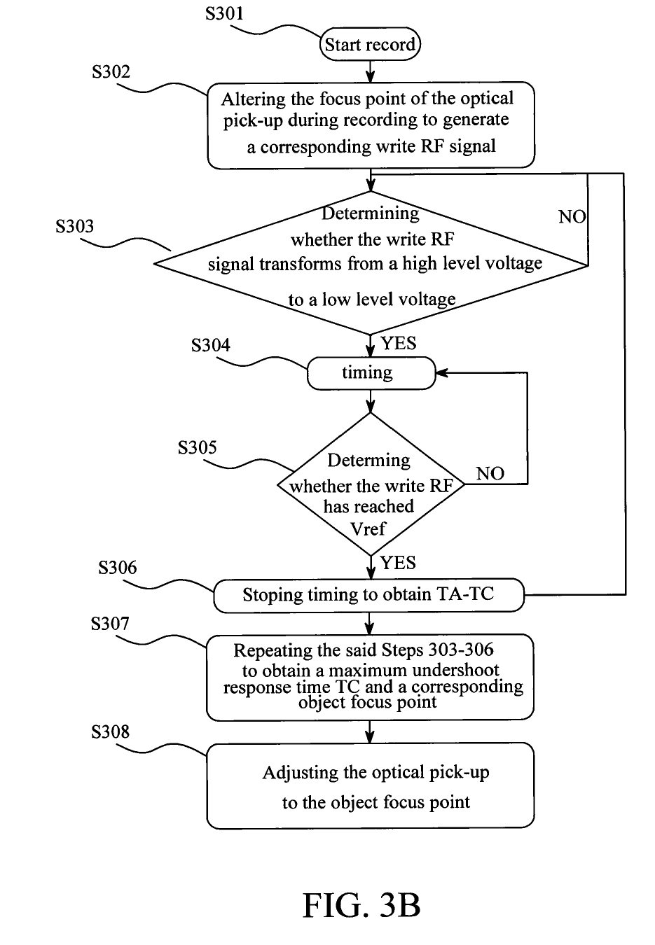

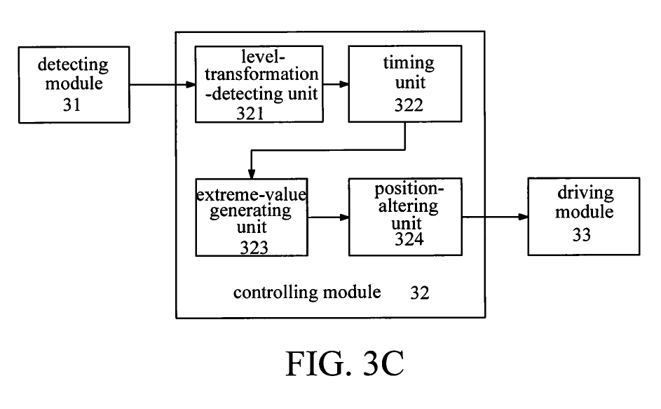

FIG. 3A is an oscillogram of a write RF signal according to the second embodiment of the present invention. Referring to FIG. 3A, in the embodiment illustrated by FIG. 2A˜FIG. 2C, adjustment of the focus position of the optical pick-up is based upon the detected minimum voltage value of the write RF signal, i.e. the minimum undershoot voltage. FIG. 3B shows a flowchart of a method for calibrating the focus position according to the second embodiment of the present invention. Referring to both FIGS. 3A and 3B, the second embodiment implies a reference voltage Vref and the above-identified steps may vary as follows:

Step S301: Starting writing;

Step S302: Altering the focus position of the optical pick-up during writing to generate a corresponding write RF signal;

Step S303: Determining whether the write RF signal transforms from a high level voltage to a low level voltage, if determined as yes, then executing Step S304, if determined as no, continuing to execute Step S303;

Step S304: Starting timing when the write RF signal transforms from a high level voltage to a low level voltage;

Step S305: Determining whether the write RF signal has reached a preset voltage Vref, wherein if the write RF signal has not reached the preset voltage Vref, the timing in Step S304 continues, and if the write RF signal has reached the preset voltage Vref, Step S306 is executed;

Step S306: Stopping timing to obtain an undershoot response time TA-TC when the write RF signal reaches the preset voltage Vref from a relatively low voltage;

Step S307: Repeating the Steps 303-306 to obtain a maximum undershoot response time TC and a corresponding object focus position;

Step S308: Adjusting the optical pick-up to the object focus position so that the optical pick-up performs subsequent writing at the object focus position in the recordable optical medium.

In the method, the situation of the focus is immediately known at the same time of writing; therefore, proper calibration of the focus position can be done during subsequent writing to improve the recording quality.

The present invention further provides a system for calibrating a maximum undershoot response time of a focus position of an optical pick-up corresponding to the method as disclosed in the second embodiment. Referring to FIG. 3C, FIG. 3C illustrates a detecting module 31, a controlling module 32, and a driving module 33:

the detecting module 31, for detecting a beam reflected from the recordable optical medium and generating a corresponding RF signal;

the controlling module 32, including a level-transformation-detecting unit 321, a timing unit 322, an extreme-value-generating unit 323, and a position-altering unit 324, wherein
the level-transformation-detecting unit 321 outputs a transformation signal when it is detected that the RF signal generated by the detecting module 31 transforms from a high level voltage to a low level voltage;
the timing unit 322 starts timing when receiving the transformation signal outputted by the level-transformation-detecting unit 321 and stops timing to obtain an undershoot response time when the write RF signal reaches a preset voltage from a relatively low voltage;
the extreme-value-generating unit 323 receives the undershoot response time and determines a maximum undershoot response time corresponding to a minimum value of the RF signal and an object focus position corresponding to the maximum undershoot response time; and
the position-altering unit 324 controls the optical pick-up with a preset position-altering program to alter the focus position during writing in the recordable optical medium; and
the driving module 33, adjusts the optical pick-up to the object focus position corresponding to the maximum undershoot response time according to the control of the controlling module 32. Herein, the RF signal is the write RF signal generated during writing process.

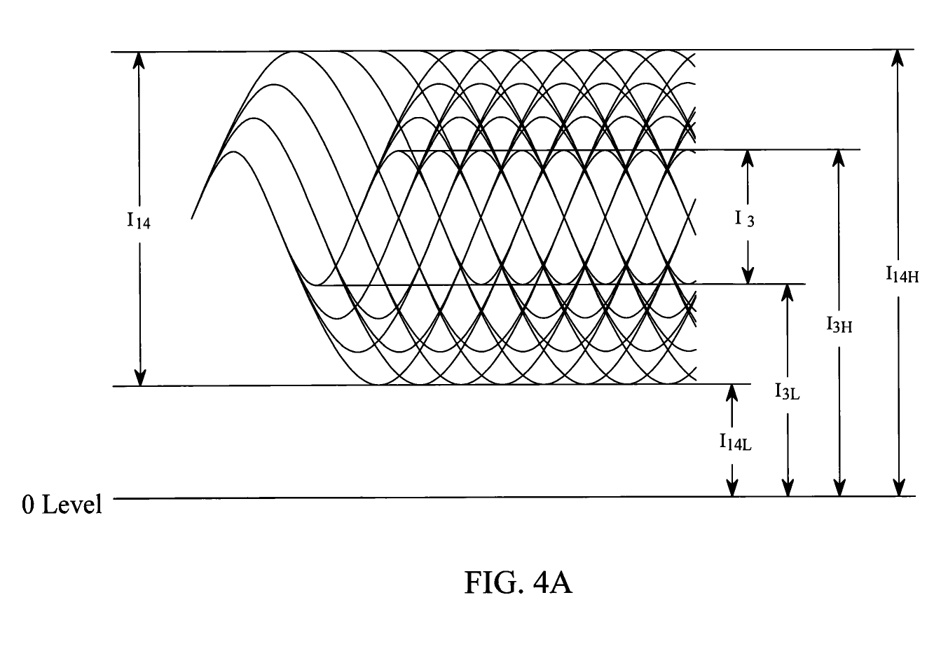

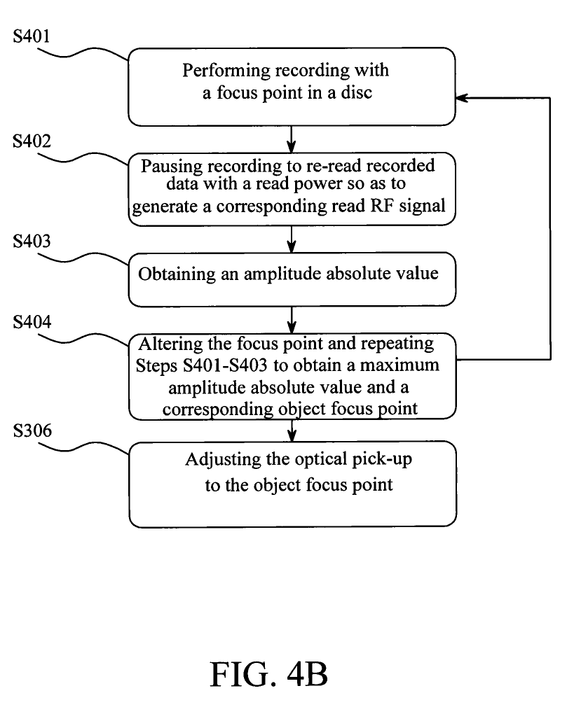

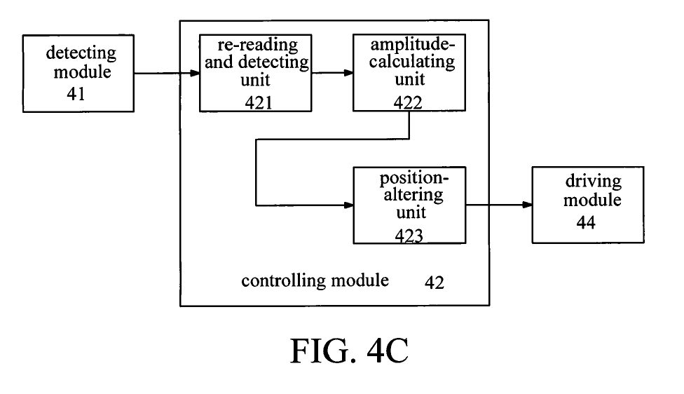

FIG. 4A is an oscillogram of a RF signal according to the third embodiment of the present invention and illustrates amplitudes I14 and I14H are illustrated. I14/I14H is defined as an I14/I14H modulation value. In the third embodiment, calibration of a focus position of an optical pick-up is based upon the I14/I14H modulation value. FIG. 4B shows a flowchart of a method for calibrating the focus position according to the third embodiment of the present invention. Referring to both FIGS. 4A and 4B, the method for calibrating the focus position of the optical pick-up includes the following:

Step S401: Performing writing at a focus position in a disc;

Step S402: Pausing writing to re-read recorded data with a read power so as to generate a corresponding read RF signal;

Step S403: Obtaining an amplitude absolute value of the read RF signal wherein the amplitude absolute value is a modulation value of I14/I14H;

Step S404: Altering the focus position and repeating Steps S401-S403 to obtain a maximum amplitude absolute value and a corresponding object focus position, wherein when the I14/I14H modulation value is maximum, the focus position is the optimal position;

Step S405: Adjusting the optical pick-up to the object focus position so that the optical pick-up performs subsequent writing at the object focus position in the recordable optical medium.

Although writing must be paused to re-read the RF signal in the third embodiment, usually only a small portion of the recorded data is required for re-reading to detect the I14/I14H modulation value. Therefore, the third embodiment still renders the entire disc with a consistent recording quality throughout.

The present invention further provides a system for calibrating a maximum modulation value of a focus position of an optical pick-up corresponding to the method as disclosed in the third embodiment. Referring to FIG. 4C, FIG. 4C illustrates a detecting module 41, a controlling module 42, and a driving module 43, wherein

the detecting module 41, detects a beam reflected from the recordable optical medium;

the controlling module 42, includes a re-reading and detecting unit 421, an amplitude-calculating unit 422, and a position-altering unit 423, wherein
the re-reading and detecting unit 421 pauses writing after to re-read written data with a read power so as to generate a corresponding read RF signal and perform detection to obtain an amplitude absolute value;
the amplitude-calculating unit 422 receives the amplitude absolute value and determines a maximum amplitude absolute value and a corresponding object focus position; and
the position-altering unit 423 controls the optical pick-up by a preset position-altering program to alter the focus position during writing in the recordable optical medium; and

the driving module 43 adjusts the optical pick-up to the object focus position according to the control of the controlling module 42. Herein, the amplitude absolute value is the I14/I14H modulation value.

The controlling module 42 further includes a second memory unit for storing the object focus position corresponding to the maximum amplitude absolute value, wherein the object focus position also corresponds to the preset position of the position-altering unit.

In summary, the spirit of the present invention lies in altering the focus position of the optical pick-up during writing to generate the undershoot voltage value and the I14/I14H modulation value corresponding to the write RF signal. Furthermore, after detecting the minimum undershoot voltage value of the write RF signal (corresponding to the maximum undershoot response time) or the maximum I14/I14H modulation value, the corresponding object focus position are determined. Afterwards, the optical pick-up is adjusted to the object focus position. The advantage of the method is that the focus position is continuously adjusted according to the undershoot voltage value of the write RF signal during writing.

In addition, the object focus position of any random position can also be determined according to the results of adjusting the focus positions of a plurality of points on a disc. Hence, the controlling module in FIGS. 2C, 3C and 4C may further include a second memory unit (not illustrated). In FIGS. 2C and 3C, the second memory unit in the controlling module stores the object focus position corresponding to the minimum RF signal value generated by the extreme-value-generating unit; the object focus position corresponds to the preset position of the position-altering unit. In FIG. 4C, the second memory unit of the controlling module stores the object focus position corresponding to the maximum amplitude absolute value; the object focus position corresponds to the preset position of the position-altering unit. Consequently, the position-altering unit directly determines the object focus position of any random position according to the results of adjusting the focus positions of a plurality of points on the disc stored by the second memory unit.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A method for calibrating a focus position of an optical pick-up, the optical pick-up being located at a focus position having a preset distance from a recordable optical medium and emitting a writing beam of a preset power to the recordable optical medium to write corresponding data in the recordable optical medium, the method comprising:
(1) performing writing at a focus position in the recordable optical medium to generate a corresponding write radio frequency (write RF) signal;
(2) detecting whether the write RF signal transforms from a high level voltage to a low level voltage, if yes, performing (3);
(3) obtaining a minimum value of the write RF signal and a corresponding object focus position; and
(4) calibrating the optical pick-up to the object focus position so that the optical pick-up performs subsequent writing at the object focus position in the recordable optical medium.

2. The method as claimed in claim 1, the step of obtaining the minimum value of the write RF signal in step (3) comprising:
(301) recording a voltage value of the current write RF signal when it is determined that the write RF signal is transformed from a high level voltage to a low level voltage; and
(302) altering the focus position and repeating step (1) to obtain the minimum voltage value of the write RF signal,
wherein the object focus position is the object focus position corresponding to the minimum voltage.

3. The method as claimed in claim 1, the step of obtaining the minimum value of the write RF signal in step (3) comprising:
(311) starting timing when it is determined that the write RF signal is transformed from the high level voltage to the low level voltage;
(312) stopping timing to obtain an undershoot response time when it is determined that the write RF signal reaches a preset voltage from a relatively low voltage; and
(313) altering the focus position and repeating step (1) to obtain a maximum undershoot response time corresponding to the minimum value of the write RF signal,
wherein the object focus position is the object focus position corresponding to the maximum undershoot response time.

4. The method as claimed in claim 1, further comprising storing the object focus position corresponding to the minimum voltage value of the write RF signal before calibrating the optical pick-up, wherein the object focus position corresponds to the focus position in step (1).

5. A method for calibrating a focus position of an optical pick-up, the optical pick-up being located at a focus position having a preset distance from a recordable optical medium and emitting a writing beam of a preset power to the recordable optical medium to write corresponding optical data in the recordable optical medium, the method comprising:
(1) performing writing at a focus position in the recordable optical medium;
(2) pausing writing to re-read recorded data with a read power to generate a corresponding RF signal;
(3) obtaining an absolute value of an amplitude with the RF signal;
(4) altering the focus position and repeating step(1) to obtain a maximum absolute value of the amplitude and a corresponding object focus position; and
(5) calibrating the optical pick-up to the object focus position so that the optical pick-up performs subsequent writing at the object focus position in the recordable optical medium.

6. The method as claimed in claim 5, further comprising storing the object focus position corresponding to the minimum value of the RF signal before calibrating the optical pick-up, wherein the object focus position corresponds to the focus position in step (1).

7. The method as claimed in claim 6, wherein the absolute value of the amplitude is an I14/I14H modulation value.

8. A system for calibrating a focus position of an optical pick-up, the optical pick-up being located on a focus position at a preset distance from a recordable optical medium and emitting a recording beam of a preset power to the recordable optical medium to write corresponding optical data in the recordable optical medium, the system comprising:
a detecting module, for detecting the writing beam reflected from the recordable optical medium and generating a corresponding write RF signal;
a controlling module, comprising:
a position-altering unit, for controlling the focus position of the optical pick-up with a preset position altering program during writing process in the recordable optical medium;
a level-transformation-detecting unit, for outputting a transformation signal when detecting that the write RF signal generated by the detecting module transforms from a high level voltage to a low level voltage; and
an extreme-value-generating unit, for obtaining a minimum value of the write RF signal and a corresponding object focus position according to the transformation signal; and
a driving module, for calibrating the optical pick-up to the object focus position according to the control of the controlling module.

9. The system as claimed in claim 8, wherein the controlling module further comprises a first memory unit, for recording a voltage value of the write RF signal when receiving the transformation signal outputted by the level-transformation-detecting unit; the extreme-value-generating unit, for receiving the voltage value and determining a minimum voltage value corresponding to the minimum value of the write RF signal and an object focus position; and the driving module, for calibrating the optical pick-up to the object focus position corresponding to the minimum voltage value.

10. The system as claimed in claim 8, wherein the controlling module further comprises a timing unit for starting timing when receiving the transformation signal outputted by the level-transformation-detecting unit and for stopping timing to obtain an undershoot response time when the write RF signal reaches a preset voltage from a relatively low voltage; the extreme-value-generating unit for receiving the undershoot response time and determining a maximum undershoot response time corresponding to the minimum value of the RF signal and an object focus position corresponding to the maximum undershoot response time; and driving module for calibrating the optical pick-up to the object focus position corresponding to the maximum undershoot response time according to the control of the controlling module.

11. The system as claimed in claim 8, wherein the controlling module further comprises a second memory unit for storing the object focus position corresponding to the minimum value of the RF signal generated by the extreme-value-generating unit, and wherein the object focus position corresponds to the preset position in the position-altering unit.

12. A system for calibrating a focus position of an optical pick-up, the optical pick-up being located at a focus position having a preset distance from an optical pick-up and emitting a recording beam of a preset power to the recordable optical medium to write corresponding optical data in the recordable optical medium, the system comprising:
a detecting module, for detecting the recording beam reflected from the recordable optical medium and generating a corresponding RF signal;
a controlling module, comprising:
a position-altering unit, for controlling the optical pick-up by a preset position altering program to alter the focus position of the optical pick-up during writing in the recordable optical medium;
a re-reading and detecting unit, for detecting the RF signal to obtain an amplitude absolute value wherein the RF signal is generated by reading back the written data after pausing; and
an amplitude-calculating unit, for receiving the amplitude absolute value and determining a maximum of the amplitude absolute value and a corresponding object focus position; and
a driving module, for calibrating the optical pick-up to the object focus position according to the control of the controlling module.

13. The system as claimed in claim 12, wherein the amplitude absolute value is an I14/I14H modulation value.

14. The system as claimed in claim 12, wherein the controlling module further comprises a second memory unit for storing the object focus position corresponding to the maximum amplitude absolute value, the object focus position corresponding to the preset position in the position-altering unit.

15. The system as claimed in claim 9, wherein the controlling module further comprises a second memory unit for storing the object focus position corresponding to the minimum value of the RF signal generated by the extreme-value-generating unit, and wherein the object focus position corresponds to the preset position in the position-altering unit.

16. The system as claimed in claim 10, wherein the controlling module further comprises a second memory unit for storing the object focus position corresponding to the minimum value of the RF signal generated by the extreme-value-generating unit, and wherein the object focus position corresponds to the preset position in the position-altering unit.

17. The system as claimed in claim 13, wherein the controlling module further comprises a second memory unit for storing the object focus position corresponding to the maximum amplitude absolute value, the object focus position corresponding to the preset position in the position-altering unit.
